(19) United States
(12) Patent Application Publication
(10) Pub. No.: US 2010/0100807 A1
(43) Pub. Date: Apr. 22, 2010

(54) DATA PROCESSING DEVICE, AND DATA PROCESSING METHOD

(75) Inventors: Noriyoshi Matsumoto, Tokushima-shi (JP); Takeshi Kanbe, Tokushima-shi (JP); Yoshinori Ito, Tokushima-shi (JP)

Correspondence Address: SUGHRUE MION, PLLC, 2100 PENNSYLVANIA AVENUE, N.W., SUITE 800, WASHINGTON, DC, 20037, US

(73) Assignee: Justsystems Corporation, Tokushima-shi, Tokushima (JP)

(21) Appl. No.: 12/444,294

(22) PCT Filed: Oct. 10, 2007
(86) PCT No.: PCT/JP2007/001100

§ 371 Date: Apr. 3, 2009

(30) Foreign Application Priority Data
Oct. 10, 2006 (JP) 2006-276770

(51) Int. Cl. G06F 3/14

(52) U.S. Cl. 715/234

(57) ABSTRACT

In a document processing apparatus, an acquiring unit acquires data described in a markup language. A processing system such as a map component, processes certain data by receiving the data. A cooperative control component extracts data to be inputted in the processing system, from the data that the acquiring unit acquires. A display control component displays a screen outputted by the processing system that has processed the data thus determined and inputted by the cooperative control component.

### FIELD OF THE INVENTION

The present invention relates to a document processing technology, in particular, to a data processing apparatus that processes data described in a markup language.

### BACKGROUND OF THE INVENTION

XML attracts attention as a form suitable for sharing data with others via a network, etc., and applications for creating, displaying and editing XML documents are developed (for example, see Patent Document 1). An XML document is created based on vocabularies (tag sets) defined by a document type definition, etc.

[Patent Document 1] Japanese Patent Laid-Open No. 2001-290804.

### DISCLOSURE OF THE INVENTION

### Problem to be Solved by the Invention

In a relational database currently used widely, it is generally difficult to change a data structure thereof that has once created, during its operation. In XML, however, a schema is not essential and a well-formed configuration is admissible; hence, expandability of an XML database is very high. Therefore, it is possible that a database is developed in the state where the specification thereof is not completely determined, or that a system is structured in a relatively easy way on the premise that the data structure thereof is to be changed halfway.

In XML, however, it is allowed to create vocabularies arbitrarily, and therefore an infinite number of vocabularies possibly exist theoretically. It is not realistic to provide a dedicated display and editing environment corresponding to these whole vocabularies. In the case of editing a document described in vocabularies for which a dedicated editing environment is not provided, it has been conventionally performed that a source of the document that is structured with text data is directly edited by a text editor or the like.

The present invention has been made in view of these circumstances, and a general purpose thereof is to provide a technology in which data structured with a markup language is appropriately processed.

### Means for Solving the Problem

An embodiment of the present invention relates to a data processing apparatus. The data processing apparatus comprises: an acquiring unit that acquires data described in a markup language; a processing system in which certain data is inputted and processed; a cooperative control unit that extracts data to be inputted into the processing system from the data acquired by the acquiring unit; and a display control unit that displays a screen outputted by the processing system in which the data, which is determined by the cooperative control unit, is inputted and processed.

When a plurality of the processing systems are activated, the cooperative control unit may also extract, from both of the data acquired by the acquiring unit and the data outputted by the processing system that has been previously activated, data to be inputted in the processing system that has been activated later.

When a plurality of the processing systems are activated, the cooperative control unit may also change an order in which the plurality of the processing systems process data. When a plurality of the processing systems are activated, the display control unit may also displays screens outputted by the plurality of the processing systems in a superimposed manner. When a plurality of the processing systems are activated, the display control unit may also change an order in which screens outputted by the plurality of the processing systems are displayed.

The cooperative control unit may also extract data to be inputted in the processing system based on at least one of an element name, an attribute name, a name space, and a data type. The cooperative control unit may also determine data to be inputted in the processing system, by presenting a candidate for the data to be inputted in the processing system to a user, and by receiving a selection of the data to be inputted therein from the user.

The cooperative control unit may also determine a processing system to be activated, based on the data.

It is noted that any combination of the aforementioned components or any manifestation of the present invention exchanged between methods, devices, systems and so forth, is effective as an embodiment of the present invention.

### ADVANTAGE OF THE INVENTION

According to the present invention, a technology can be provided in which data structured by an markup language is appropriately processed.

### BRIEF DESCRIPTION OF THE DRAWINGS

FIG. 1 is a diagram illustrating a structure of a document processing apparatus directed to Base Technology;

FIG. 2 is a diagram illustrating an example of an XML document that is to be edited by the document processing apparatus;

FIG. 3 is a diagram illustrating an example of mapping the XML document illustrated in FIG. 2 to a table described in HTML;

FIG. 4(a) is a diagram illustrating an example of a definition file for mapping the XML document illustrated in FIG. 2 to the table illustrated in FIG. 3;

FIG. 4(b) is a diagram illustrating an example of a definition file for mapping the XML document illustrated in FIG. 2 to the table illustrated in FIG. 3;

FIG. 5 is a diagram illustrating an example of a screen on which the XML document illustrated in FIG. 2 is displayed by mapping the XML document to HTML using the correspondence illustrated in FIG. 3;

FIG. 6 is a diagram illustrating an example of a graphical user interface that the definition file creating unit presents to the user in order for the user to create a definition file;

FIG. 7 is a diagram illustrating another example of a screen layout created by the definition file creating unit;

FIG. 8 is a diagram illustrating an example of an edit screen on which an XML document is edited by the document processing apparatus;

FIG. 9 is a diagram illustrating another example an XML document edited by the document processing apparatus;

FIG. 10 is a diagram illustrating an example of a screen on which the document illustrated in FIG. 9 is displayed; and

FIG. 11 is a diagram illustrating a structure of the document processing apparatus directed to the embodiment.

### REFERENCE NUMERALS

20 DOCUMENT PROCESSING APPARATUS
22 MAIN CONTROL UNIT
24 EDIT UNIT
30 DOM UNIT
32 DOM PROVIDER,
34 DOM CREATING UNIT
36 DOM WRITER
40 CSS UNIT
42 CSS PARSER
44 CSS PROVIDER
46 RENDERING UNIT
50 HTML UNIT
52, 62 CONTROL UNIT
54, 64 EDIT UNIT
56, 66 DISPLAY UNIT
60 SVG UNIT
70 ACQUIRING UNIT
71 COOPERATIVE CONTROL COMPONENT
72 MAP COMPONENT
73 POINT COMPONENT
74 COLOR COMPONENT
75 COURSE PATHWAY COMPONENT
76 PROGRESS BAR COMPONENT
77 DISPLAY CONTROL COMPONENT
80 VC UNIT
82 MAPPING UNIT
84 DEFINITION FILE ACQUIRING UNIT
86 DEFINITION FILE CREATING UNIT
100 DOCUMENT PROCESSING APPARATUS

### BEST MODE OF CARRYING OUT THE INVENTION

### Base Technology

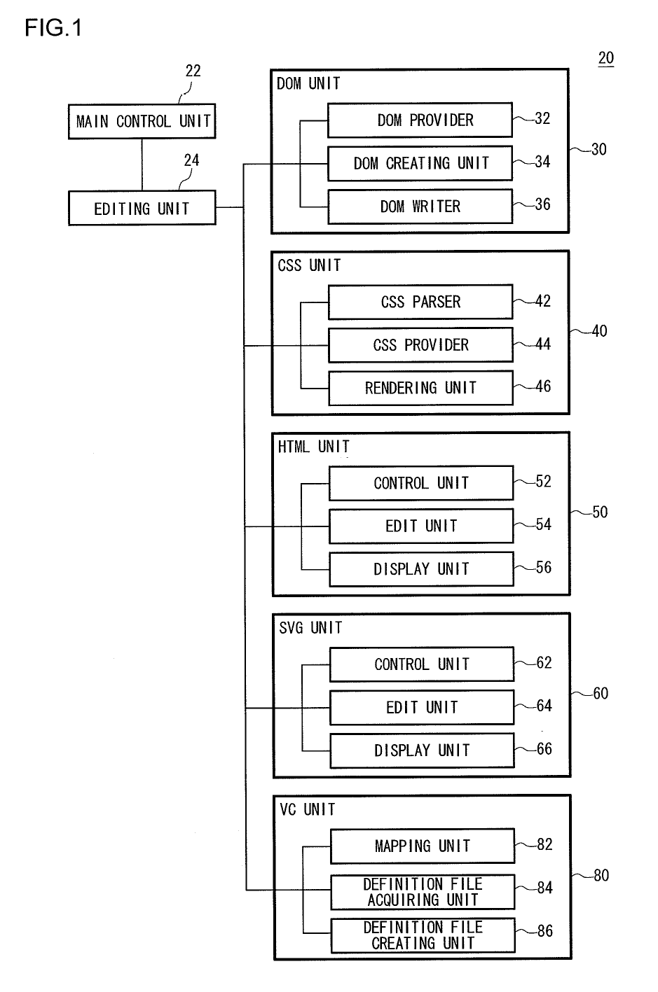

FIG. 1 illustrates a structure of a document processing apparatus 20 directed to Base Technology. The document processing apparatus 20 processes a structured document where data in the document are classified into a plurality of components having a hierarchical structure. Represented in Base Technology is an example in which an XML document, as one type of a structured document, is processed. The document processing apparatus 20 comprises a main control unit 22, an edit unit 24, a DOM unit 30, a CSS unit 40, an HTML unit 50, an SVG unit 60 and a VC unit 80 that is an example of a conversion unit. In terms of hardware components, these unit structures may be realized by any conventional processing system or equipment, including a CPU or memory of any computer, a memory-loaded program, or the like. Here, the drawing illustrates functional blocks that are realized by cooperation between the hardware components and software components. Thus, it should be understood by a person skilled in the art that these functional blocks can be realized in a variety of forms by hardware only, software only or the combination thereof.

The main control unit 22 provides loading of a plug-in or a framework for executing a command. The edit unit 24 provides a framework for editing XML documents. Display and editing functions for a document in the document processing apparatus 20 are realized by plug-ins, and the necessary plug-ins are loaded by the main control unit 22 or the edit unit 24 according to the type of a document under consideration. The main control unit 22 or the edit unit 24 determines which vocabulary or vocabularies describes the content of an XML document to be processed, by referring to a name space of the document to be processed, and loads a plug-in for display or editing corresponding to the thus determined vocabulary so as to execute the display or the editing. For instance, an HTML unit 50, which displays and edits HTML documents, and an SVG unit 60, which displays and edits SVG documents, are implemented in the document processing apparatus 20. That is, a display system and an editing system are implemented as plug-ins for each vocabulary (tag set), so that when an HTML document and an SVG document are edited, HTML unit 50 and the SVG unit 60 are loaded, respectively. As will be described later, when compound documents, which contain both HTML and SVG components, are to be processed, both HTML unit 50 and the SVG unit 60 are loaded.

By implementing the above structure, a user can select so as to install only necessary functions, and can add or delete a function or functions at a later stage, as appropriately. Thus, the storage area of a recording medium, such as a hard disk, can be effectively utilized, and the wasteful use of memory can be prevented at the time of executing programs. Furthermore, since the capability of this structure is highly expandable, a developer can deal with new vocabularies in the form of plug-ins, and thus the development process can be readily facilitated. As a result, the user can also add a function or functions easily at low cost by adding a plug-in or plug-ins.

The edit unit 24 receives an event, which is an editing instruction, from the user via the user interface. Upon reception of such an event, the edit unit 24 notifies a suitable plug-in or the like of this event, and controls the processing such as redoing this event, canceling (undoing) this event, etc.

The DOM unit 30 includes a DOM provider 32, a DOM creating unit 34 and a DOM writer 36. The DOM unit 30 realizes functions in compliance with a document object model (DOM), which is defined to provide an access method used for handling data in the form of an XML document. The DOM provider 32 is an implementation of a DOM that satisfies an interface defined by the edit unit 24. The DOM creating unit 34 creates DOM trees from XML documents. As will be described later, when an XML document to be processed is mapped to another vocabulary by the VC unit 80, a source tree, which corresponds to the XML document in a mapping source, and a destination tree, which corresponds to the XML document in a mapping destination, are created. At the end of editing, for example, the DOM writer 36 outputs a DOM tree as an XML document.

The CSS unit 40, which provides a display function conforming to CSS, includes a CSS parser 42, a CSS provider 44 and a rendering unit 46. The CSS parser 42 has a parsing function for analyzing the CSS syntax. The CSS provider 44 is an implementation of a CSS object and performs CSS cascade processing on the DOM tree. The rendering unit 46 is a CSS rendering engine and is used to display documents, described in a vocabulary such as HTML, which are laid out using CSS.

HTML unit 50 displays or edits documents described in HTML. The SVG unit 60 displays or edits documents described in SVG. These display/editing systems are realized in the form of plug-ins, and each system is comprised of a display unit (also designated herein as a “canvas”) 56 and 66, which displays documents, a control unit (also designated herein as an “editlet”) 52 and 62, which transmits and receives events containing editing commands, and an edit unit (also designated herein as a “zone”) 54 and 64, which edits the DOM according to the editing commands. Upon the control unit 52 or 62 receiving a DOM tree editing command from an external source, the edit unit 54 or 64 modifies the DOM tree and the display unit 56 or 66 updates the display. These units have a structure similar to the framework of the so-called MVC (Model-View-Controller). With such a structure, in general, the display units 56 and 66 correspond to “View”. On the other hand, the control units 52 and 62 correspond to “Controller”, and the edit units 54 and 64 and DOM instance corresponds to “Model”. The document processing apparatus 20 according to the Base Technology allows an XML document to be edited according to each given vocabulary, as well as providing a function of editing HTML document in the form of tree display. HTML unit 50 provides a user interface for editing an HTML document in a manner similar to a word processor, for example. On the other hand, the SVG unit 60 provides a user interface for editing an SVG document in a manner similar to an image drawing tool.

The VC unit 80 includes a mapping unit 82, a definition file acquiring unit 84 and a definition file creating unit 86. The VC unit 80 performs mapping of a document, which has been described in a particular vocabulary, to another given vocabulary, thereby providing a framework that allows a document to be displayed and edited by a display/editing plug-in corresponding to the vocabulary to which the document is mapped. In the Base Technology, this function is called a vocabulary connection (VC). In the VC unit 80, the definition file acquiring unit 84 acquires a script file in which the mapping definition is described. Here, the definition file specifies the correspondence (connection) between the Nodes for each Node. Furthermore, the definition file may specify whether or not editing of the element values or attribute values is permitted. Furthermore, the definition file may include operation expressions using the element values or attribute values for the Node. Detailed description will be made later regarding these functions. The mapping unit 82 instructs the DOM creating unit 34 to create a destination tree with reference to the script file acquired by the definition file acquiring unit 84. This manages the correspondence between the source tree and the destination tree. The definition file creating unit 86 presents a graphical user interface that allows the user to create a definition file.

The VC unit 80 monitors the connection between the source tree and the destination tree. Upon reception of an editing instruction from the user via a user interface provided by a plug-in that handles a display function, the VC unit 80 first modifies a relevant Node of the source tree. As a result, the DOM unit 30 issues a mutation event indicating that the source tree has been modified. Upon reception of the mutation event thus issued, the VC unit 80 modifies a Node of the destination tree corresponding to the modified Node, thereby updating the destination tree in a manner that synchronizes with the modification of the source tree. Upon reception of a mutation event that indicates that the destination tree has been modified, a plug-in having functions of displaying/editing the destination tree, e.g., HTML unit 50, updates a display with reference to the destination tree thus modified. Such a structure allows a document described in any vocabulary, even a local vocabulary used in a minor user segment, to be converted into a document described in another major vocabulary. This enables such a document described in a local vocabulary to be displayed, and provides an editing environment for such a document.

An operation in which the document processing apparatus 20 displays and/or edits documents will be described herein below. When the document processing apparatus 20 loads a document to be processed, the DOM creating unit 34 creates a DOM tree from the XML document. The main control unit 22 or the edit unit 24 determines which vocabulary describes the XML document by referring to a name space of the XML document to be processed. If the plug-in corresponding to the vocabulary is installed in the document processing apparatus 20, the plug-in is loaded so as to display/edit the document. If, on the other hand, the plug-in is not installed in the document processing apparatus 20, a check shall be made to see whether a mapping definition file exists or not. And if the definition file exits, the definition file acquiring unit 84 acquires the definition file and creates a destination tree according to the definition, so that the document is displayed/edited by the plug-in corresponding to the vocabulary which is to be used for mapping. If the document is a compound document containing a plurality of vocabularies, relevant portions of the document are displayed/edited by plug-ins corresponding to the respective vocabularies, as will be described later. If the definition file does not exist, a source or tree structure of a document is displayed and the editing is carried out on the display screen.

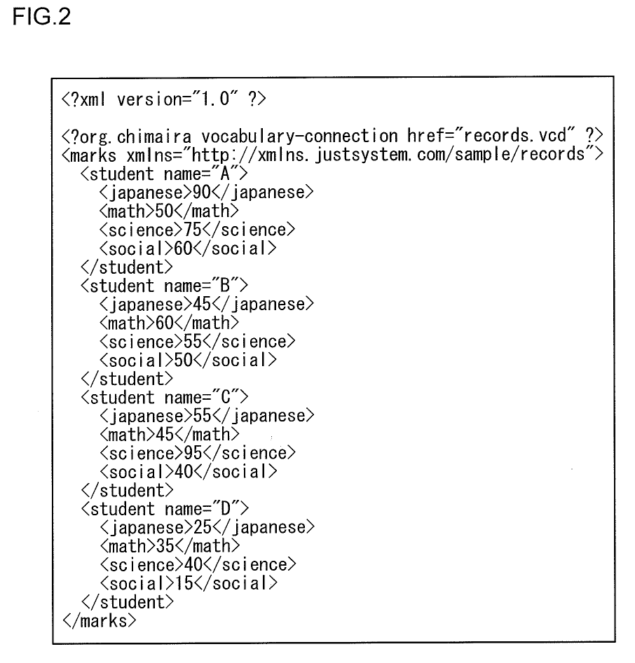

FIG. 2 illustrates an example of an XML document to be processed. According to this exemplary illustration, the XML document is used to manage data concerning grades or marks that students have earned. A component “marks”, which is the top Node of the XML document, includes a plurality of components “student” provided for each student under “marks”. The component “student” has an attribute “name” and contains, as child elements, the subjects “japanese”, “mathematics”, “science”, and “social_studies”. The attribute “name” stores the name of a student. The components “japanese”, “mathematics”, “science” and “social_studies” store the test scores for the subjects Japanese, mathematics, science, and social studies, respectively. For example, the marks of a student whose name is “A” are “90” for Japanese, “50” for mathematics, “75” for science and “60” for social studies. Hereinafter, the vocabulary (tag set) used in this document will be called “marks managing vocabulary”.

Here, the document processing apparatus 20 according to the Base Technology does not have a plug-in that conforms to or handles the display/editing of marks managing vocabularies. Accordingly, before displaying such a document in a manner other than the source display manner or the tree display manner, the above-described VC function is used. That is, there is a need to prepare a definition file for mapping the document, which has been described in the marks managing vocabulary, to another vocabulary, which is supported by a corresponding plug-in, e.g., HTML or SVG. It is noted that description will be made later regarding a user interface that allows the user to create the user's own definition file. Now, description will be made below regarding a case in which a definition file has already been prepared.

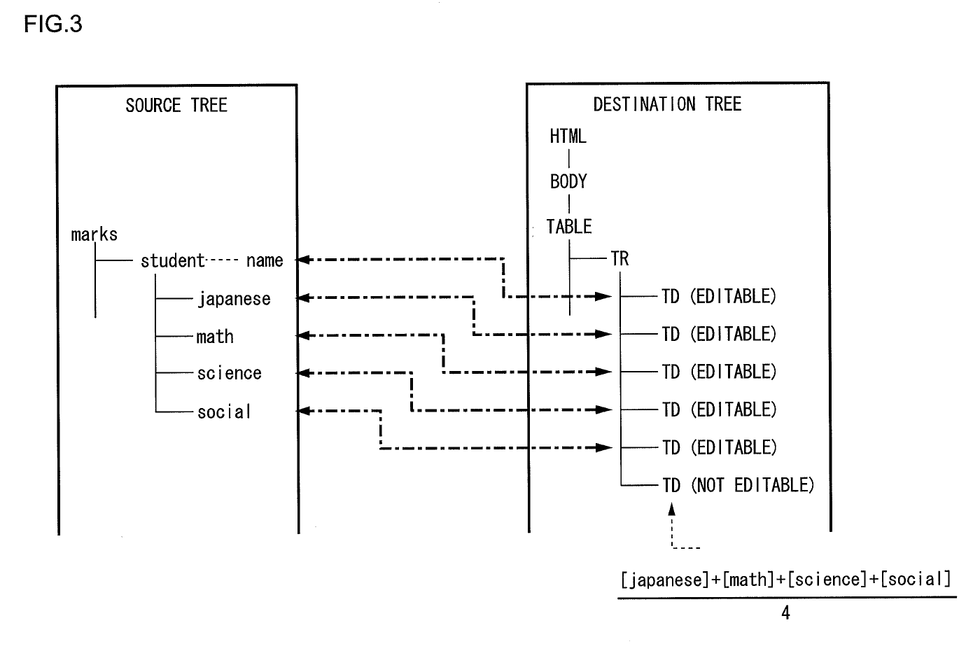

FIG. 3 illustrates an example of mapping the XML document illustrated in FIG. 2 to a table described in HTML. In an example illustrated in FIG. 3, a “student” Node in the marks managing vocabulary is associated with a row (“TR” Node) of a table (“TABLE” Node) in HTML. The first column in each row corresponds to an attribute value “name”, the second column to a “japanese” Node element value, the third column to a “mathematics” Node element value, the fourth column to a “science” Node element value and the fifth column to a “social_studies” Node element value. As a result, the XML document illustrated in FIG. 2 can be displayed in an HTML tabular format. Furthermore, these attribute values and element values are designated as being editable, so that the user can edit these values on a display screen using an editing function of HTML unit 50. In the sixth column, an operation expression is designated for calculating a weighted average of the marks for Japanese, mathematics, science and social studies, and average values of the marks for each student are displayed. In this manner, more flexible display can be effected by making it possible to specify the operation expression in the definition file, thus improving the users' convenience at the time of editing. In this example illustrated in FIG. 3, editing is designated as not being possible in the sixth column, so that the average value alone cannot be edited individually. Thus, in the mapping definition it is possible to specify editing or no editing so as to protect the users against the possibility of performing erroneous operations.

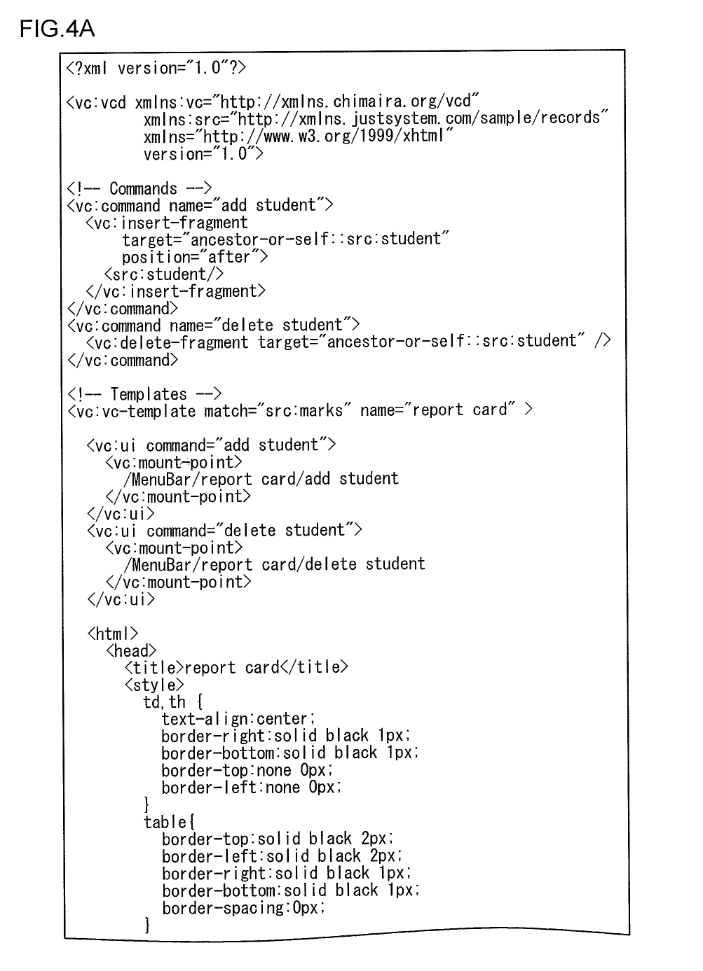

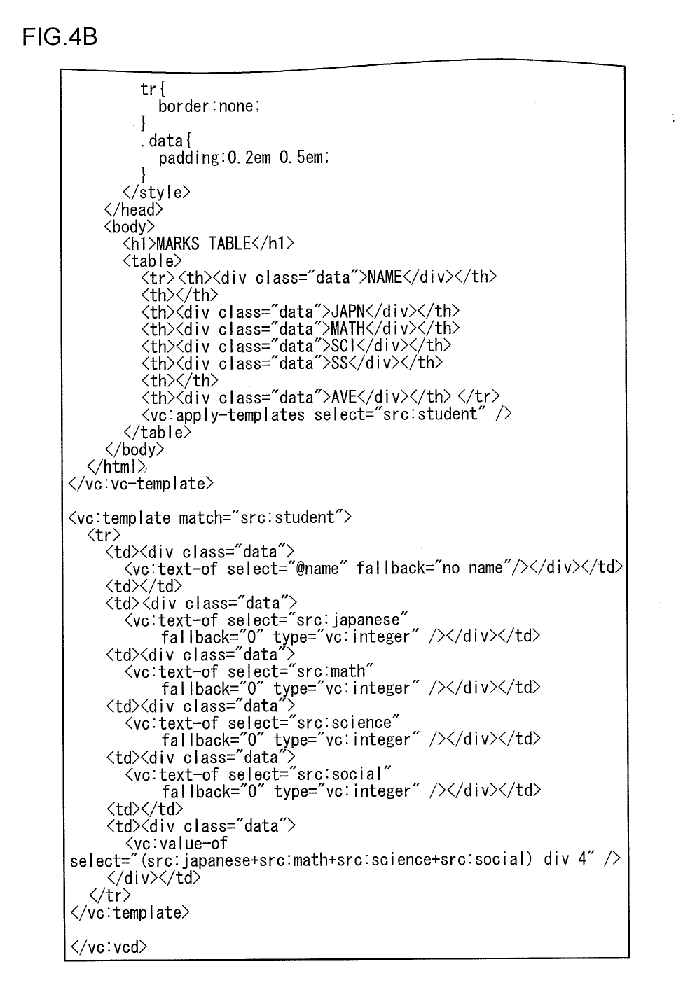

FIG. 4(a) and FIG. 4(b) illustrate examples of definition files for mapping the XML document illustrated in FIG. 2 to the table illustrated in FIG. 3. These definition files are described in a script language defined for use with definition files. In the definition files, definitions of commands and templates for display are described. In the examples illustrated in FIGS. 4(a) and 4(b), “add student” and “delete student” are defined as commands, and an operation of inserting a Node “student” into a source tree and an operation of deleting the Node “student” from the source tree, respectively, are associated with these commands. Furthermore, the definition file is described in the form of a template, which describes that a header, such as “name” and “japanese”, is displayed in the first row of a table and the contents of the Node “student” are displayed in the second and subsequent rows. In the template displaying the contents of the Node “student”, a term containing “text-of” indicates that “editing is permitted”, whereas a term containing “value-of” indicates that “editing is not permitted”. Among the rows where the contents of the Node “student” are displayed, an operation expression “(src:japanese+src:mathematics+scr:science+scr:social_studies) div 4” is described in the sixth row. This means that the average of the student's marks is displayed.

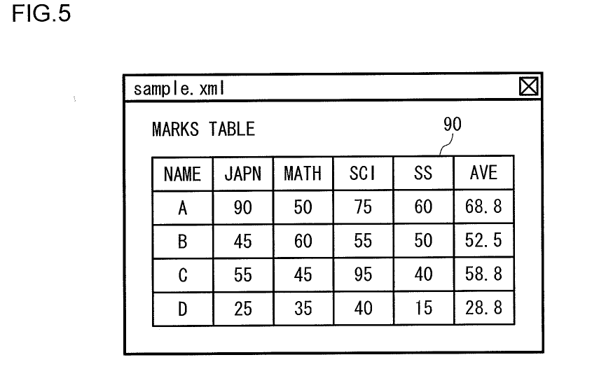

FIG. 5 illustrates an example of a screen on which the XML document described in the marks managing vocabulary illustrated in FIG. 2 is displayed by mapping the XML document to HTML using the correspondence illustrated in FIG. 3. Displayed from left to right in each row of a table 90 are the names of each student, marks for Japanese, marks for mathematics, marks for science, marks for social studies and the averages thereof. The user can edit the XML document on this screen. For example, when the value in the second row and the third column is changed to “70”, the element value in the source tree corresponding to this Node, that is, the marks of student “B” for mathematics are changed to “70”. At this time, in order to have the destination tree follow the source tree, the VC unit 80 changes a relevant portion of the destination tree accordingly, so that HTML unit 50 updates the display based on the destination tree thus changed. Hence, the marks of student “B” for mathematics are changed to “70”, and the average is changed to “55” in the table on the screen.

On the screen as illustrated in FIG. 5, commands like “add student” and “delete student” are displayed in a menu as defined in the definition file illustrated in FIGS. 4(a) and 4(b). When the user selects a command from among these commands, a Node “student” is added or deleted in the source tree. In this manner, with the document processing apparatus 20 according to the Base Technology, it is possible not only to edit the element values of components in a lower end of a hierarchical structure but also to edit the hierarchical structure. An edit function for editing such a tree structure may be presented to the user in the form of commands. Furthermore, a command to add or delete rows of a table may, for example, be linked to an operation of adding or deleting the Node “student”. A command to embed other vocabularies therein may be presented to the user. This table may be used as an input template, so that marks data for new students can be added in a fill-in-the-blank format. As described above, the VC function allows a document described in the marks managing vocabulary to be edited using the display/editing function of HTML unit 50.

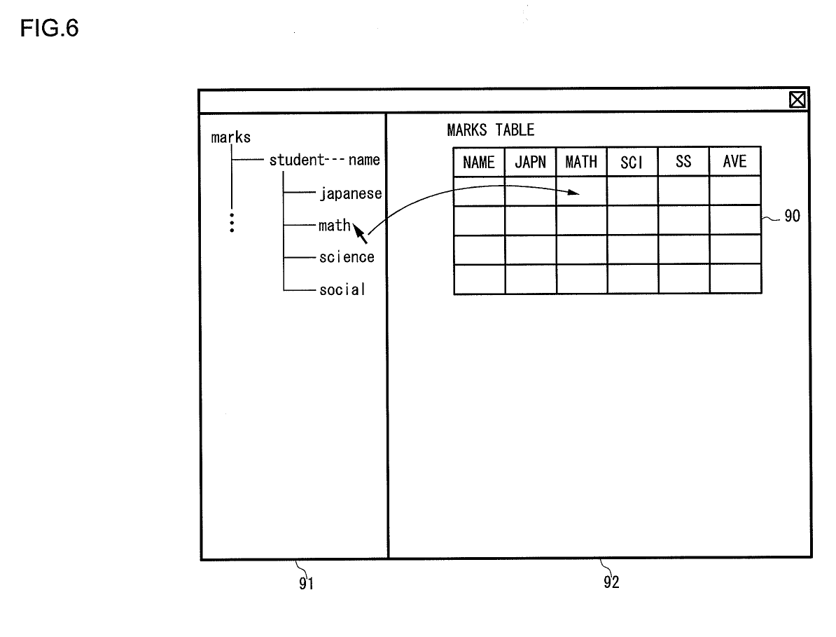

FIG. 6 illustrates an example of a graphical user interface that the definition file creating unit 86 presents to the user in order for the user to create a definition file. An XML document to be mapped is displayed in a tree in a left-hand area 91 of a screen. The screen layout of an XML document after mapping is displayed in a right-hand area 92 of the screen. This screen layout can be edited by HTML unit 50, and the user creates a screen layout for displaying documents in the right-hand area 92 of the screen. For example, a Node of the XML document which is to be mapped, which is displayed in the left-hand area 91 of the screen, is dragged and dropped into HTML screen layout in the right-hand area 92 of the screen using a pointing device such as a mouse, so that a connection between a Node at a mapping source and a Node at a mapping destination is specified. For example, when “mathematics,” which is a child element of the element “student,” is dropped to the intersection of the first row and the third column in a table 90 on HTML screen, a connection is established between the “mathematics” Node and a “TD” Node in the third column. Either editing or no editing can be specified for each Node. Moreover, the operation expression can be embedded in a display screen. When the screen editing is completed, the definition file creating unit 86 creates definition files, which describe connections between the screen layout and Nodes.

Viewers or editors that can handle major vocabularies such as XHTML, MathML and SVG have already been developed. However, it does not serve any practical purpose to develop dedicated viewers or editors for such documents described in the original vocabularies as illustrated in FIG. 2. If, however, the definition files for mapping to other vocabularies are created as mentioned above, the documents described in the original vocabularies can be displayed and/or edited utilizing the VC function without the need to develop a new viewer or editor.

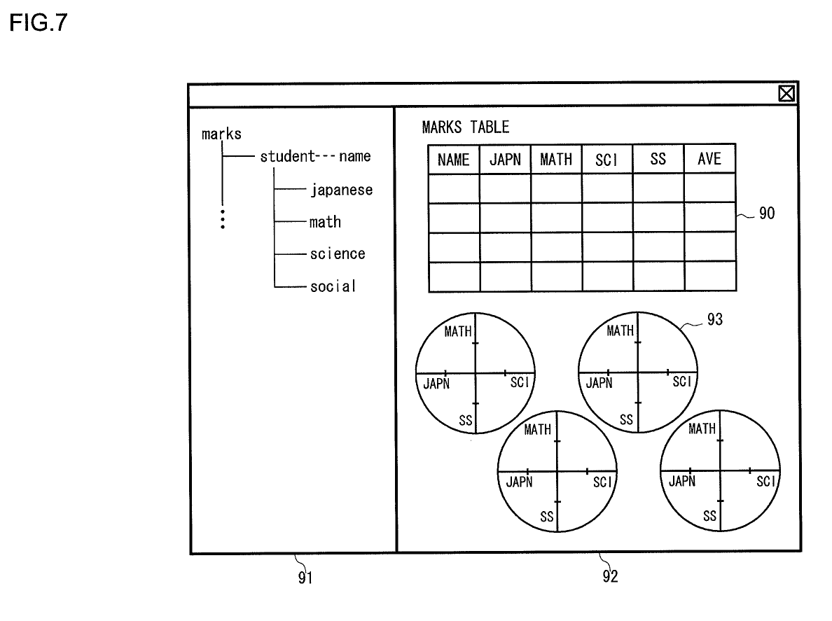

FIG. 7 illustrates another example of a screen layout created by the definition file creating unit 86. In the example illustrated in FIG. 7, a table 90 and circular graphs 93 are created on a screen for displaying XML documents described in the marks managing vocabulary. The circular graphs 93 are described in SVG. As will be discussed later, the document processing apparatus 20 according to the Base Technology can process a compound document containing a plurality of vocabularies in a single XML document. That is why the table 90 described in HTML and the circular graphs 93 described in SVG can be displayed on the same screen, as illustrated in this example.

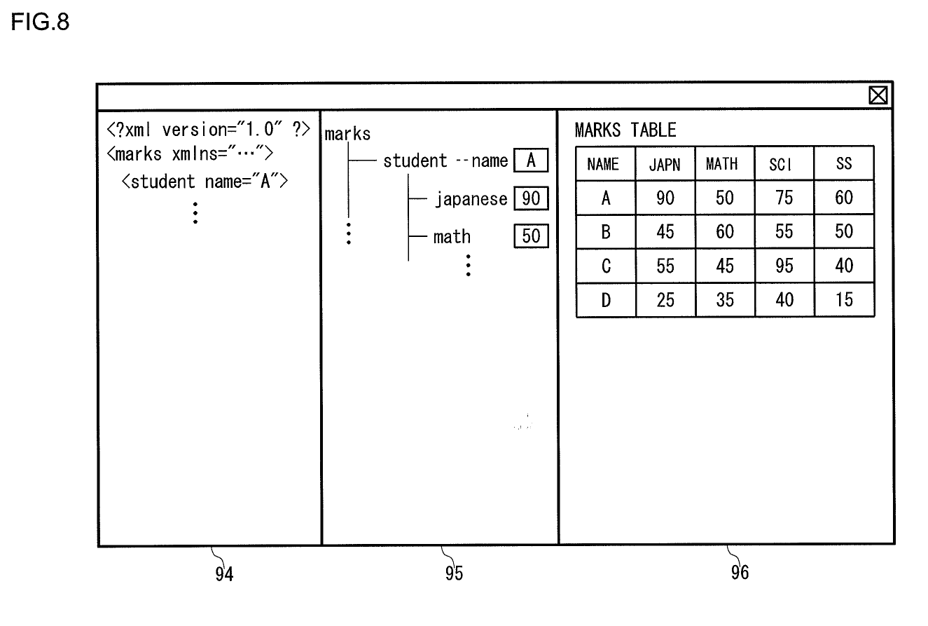

FIG. 8 illustrates an example of an edit screen in which an XML document is edited by the document processing apparatus 20. In the example illustrated in FIG. 8, a single screen is partitioned into a plurality of areas and the XML document to be processed is displayed in a plurality of different display formats at the respective areas. The source of the document is displayed in an area 94, the tree structure of the document is displayed in an area 95, and the table illustrated in FIG. 5 and described in HTML is displayed in an area 96. The document can be edited in any of these areas, and when the user edits content in any of these areas, the source tree will be modified accordingly, and then each plug-in that handles the corresponding screen display updates the screen so as to effect the modification of the source tree. Specifically, display units of the plug-ins in charge of displaying the respective edit screens are registered in advance as listeners for mutation events that provide notice of a change in the source tree. When the source tree is modified by any of the plug-ins or the VC unit 80, all the display units, which are displaying the edit screen, receive the issued mutation event (s) and then update the screens. At this time, if the plug-in is executing the display through the VC function, the VC unit 80 modifies the destination tree following the modification of the source tree. Thereafter, the display unit of the plug-in modifies the screen by referring to the destination tree thus modified.

For example, when the source display and tree display are implemented by dedicated plug-ins, the source-display plug-in and the tree-display plug-in execute their respective displays by directly referring to the source tree without involving the destination tree. In this case, when the editing is done in any area of the screen, the source-display plug-in and the tree-display plug-in update the screen by referring to the modified source tree. Also, HTML unit 50 in charge of displaying the area 96 updates the screen by referring to the destination tree, which has been modified following the modification of the source tree.

The source display and the tree display can also be realized by utilizing the VC function. That is to say, an arrangement may be made in which the source and the tree structures are laid out in HTML, an XML document is mapped to HTML structure thus laid out, and HTML unit 50 displays the XML document thus mapped. In such an arrangement, three destination trees in the source format, the tree format and the table format are created. If the editing is carried out in any of the three areas on the screen, the VC unit 80 modifies the source tree, and thereafter modifies the three destination trees in the source format, the tree format and the table format, respectively. Then, HTML unit 50 updates the three screens by referring to the three destination trees.

In this manner, a document is displayed on a single screen in a plurality of display formats, thus improving a user's convenience. For example, the user can display and edit a document in a visually easy-to-understand format using the table 90 or the like while understanding the hierarchical structure of the document by the source display or the tree display. In the above example, a single screen is partitioned into a plurality of display formats, and they are displayed simultaneously. Also, a single display format may be displayed on a single screen so that the display format can be switched according to the user's instructions. In this case, the main control unit 22 receives from the user a request for switching the display format and then instructs the respective plug-ins to switch the display.

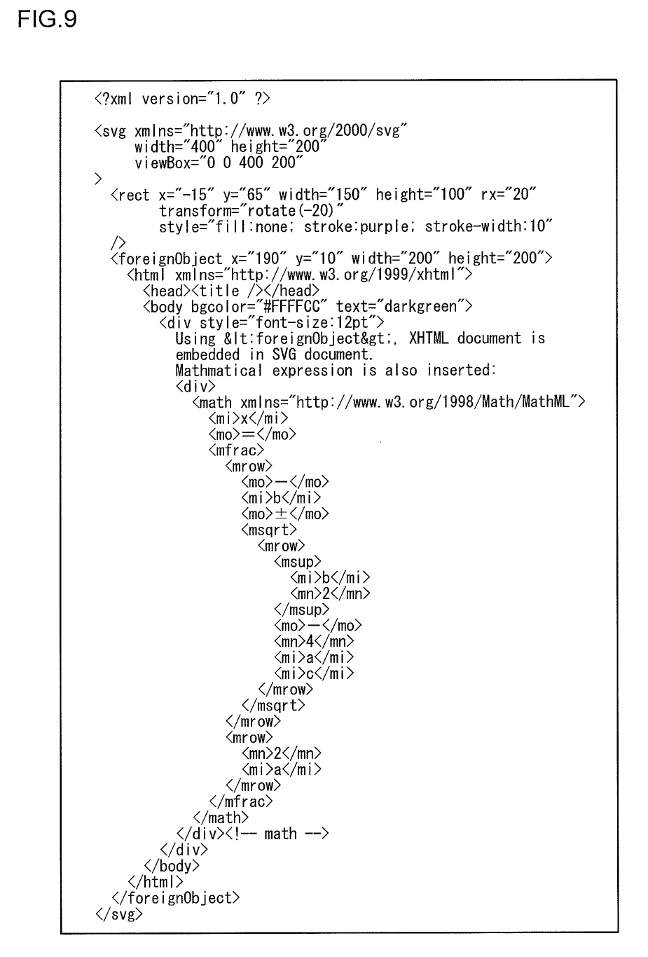

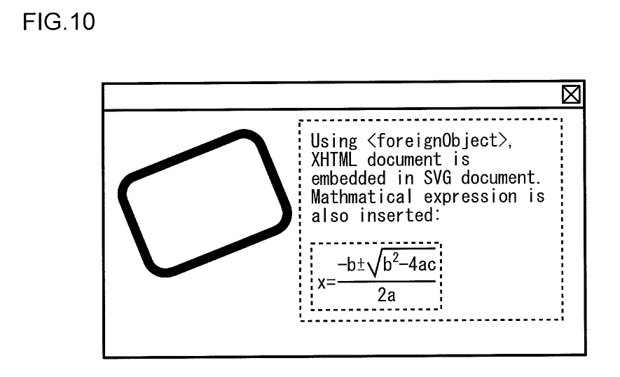

FIG. 9 illustrates another example of an XML document edited by the document processing apparatus 20. In the XML document illustrated in FIG. 9, an XHTML document is embedded in a “foreignObject” tag of an SVG document, and the XHTML document contains an equation described in MathML. In this case, the edit unit 24 assigns the rendering job to an appropriate display system by referring to the name space. In the example illustrated in FIG. 9, first, the edit unit 24 instructs the SVG unit 60 to render a rectangle, and then instructs HTML unit 50 to render the XHTML document. Furthermore, the edit unit 24 instructs a MathML unit (not illustrated) to render an equation. In this manner, the compound document containing a plurality of vocabularies is appropriately displayed. FIG. 10 illustrates the resulting display.

The displayed menu may be switched corresponding to the position of the cursor (carriage) during the editing of a document. That is, when the cursor lies in an area where an SVG document is displayed, the menu provided by the SVG unit 60, or a command set that is defined in the definition file for mapping the SVG document, is displayed. On the other hand, when the cursor lies in an area where the XHTML document is displayed, the menu provided by HTML unit 50, or a command set which is defined in the definition file for mapping HTML document, is displayed. Thus, an appropriate user interface can be presented according to the editing position.

In the case where there is neither a plug-in nor a mapping definition file suitable for any one of the vocabularies according to which the compound document has been described, a portion described in this vocabulary may be displayed in source or in tree format. In the conventional practice, when a compound document is to be opened where another document is embedded in a given document, their contents cannot be displayed without the installation of an application to display the embedded document. According to the Base Technology, however, the XML documents, which are composed of text data, may be displayed in source or in tree format so that the contents of the documents can be ascertained. This is a characteristic of the text-based XML documents or the like.

Another advantageous aspect of the data being described in a text-based language, for example, is that, in a compound document, a part of the compound document described in a given vocabulary can be used as reference data for another part of the same compound document described in a different vocabulary. Furthermore, when a search is made within the document, a string of characters embedded in a drawing, such as SVG, may also be search candidates.

In a document described in a particular vocabulary, tags belonging to other vocabularies may be used. Though such an XML document is generally not valid, it can be processed as a valid XML document as long as it is well-formed. In such a case, the tags thus inserted that belong to other vocabularies may be mapped using a definition file. For instance, tags such as “Important” and “Most Important” may be used in an XHTML document so as to display a portion surrounding these tags in an emphasized manner, or may be sorted out in the command of importance.

When the user edits a document on an edit screen as illustrated in FIG. 10, a plug-in or the VC unit 80, which is in charge of processing the edited portion, modifies the source tree. A listener for mutation events can be registered for each Node in the source tree. Normally, a display unit of the plug-in or the VC unit 80 conforming to a vocabulary to which each Node belong is registered as the listener. When the source tree is modified, the DOM provider 32 traces toward a higher hierarchy from the modified Node. If there is a registered listener, the DOM provider 32 issues a mutation event to the listener. For example, referring to the document illustrated in FIG. 9, if a Node which lies lower than the <html> Node is modified, the mutation event is notified to HTML unit 50, which is registered as a listener to the <html> Node. At the same time, the mutation event is also notified to the SVG unit 60, which is registered as a listener in an <svg> Node, which lies upper to the <html> Node. At this time, HTML unit 50 updates the display by referring to the modified source tree. Since the Nodes belonging to the vocabulary of the SVG unit 60 itself are not modified, the SVG unit 60 may disregard the mutation event.

Depending on the contents of the editing, modification of the display by HTML unit 50 may change the overall layout. In such a case, the layout is updated by a screen layout management mechanism, e.g., the plug-in that handles the display of the highest Node, in display regions that are displayed according to the respective plug-ins. For example, in the case of expanding a display region managed by HTML unit 50, first, HTML unit 50 renders a part managed by HTML unit 50 itself, and determines the size of the display region. Then, the size of the display area is notified to the component that manages the screen layout so as to request the updating of the layout. Upon receipt of this notice, the component that manages the screen layout rebuilds the layout of the display area for each plug-in. Accordingly, the display of the edited portion is appropriately updated and the overall screen layout is updated.

### Embodiment

In an embodiment, a technology is presented in which data are associated with each other between documents or document processing systems, while a plurality of documents are being processed.

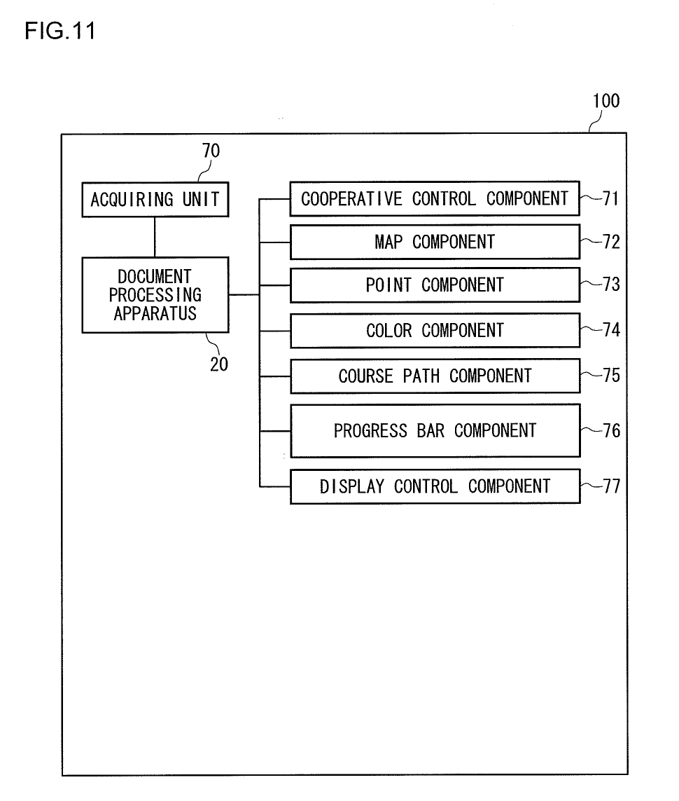

FIG. 11 illustrates a structure of the document processing apparatus directed to the present embodiment. The document processing apparatus 100 of the present embodiment comprises an acquiring unit 70, a cooperative control component 71, a map component 72, a point component 73, a color component 74, a course pathway component 75, a progress bar component 76, a display control component 77, in addition to the structure of the document processing apparatus 20 in the Base Technology illustrated in FIG. 1. The map component 72, the point component 73, the color component 74, the course pathway component 75, and the progress bar component 76 are processing systems that process data described in a document so that various functions are provided. Hereinafter, these are simply referred to as a “processing system”, when collectively called.

The cooperative control component 71 controls the cooperation between processing systems, or the cooperation between data included documents to be processed. Each processing system has a function of creating a view by processing certain inputted data. The cooperative control component 71 extracts data to be inputted in the processing system, from the data acquired by the acquiring unit 70, or from the data described in a different document that has been already designated as a processing candidate in the document processing apparatus 100, or from the data outputted by a different processing system that has been already activated in the document processing apparatus 100. Each processing system defines a specification or a condition of data to be inputted, and notifies it to the cooperative control component 71. When the processing system is activated, the cooperative control component 71 extracts candidates for data that is available as the data to be inputted in the processing system. The cooperative control component 71 may also extract data to be inputted in the processing system based on at least one of an element name, an attribute name, a name space, and a data type. The cooperative component 71 or the activated processing system may determine which data is to be inputted among the extracted candidates, or a user may determine it after accepting an inquiry. The activated processing system may be applied to the inputted data once or more than once in a loop. The display control component 77 displays a screen outputted by the processing system that has processed the inputted data.

The map component 72 has a function of, for example, rendering a map by receiving data indicating a place-name and data indicating a terrain. When a document described in vocabularies for describing these data is acquired, or when the user requests the application of the map component 72, the cooperative control component 71 activates the map component 72, and extracts data that can be inputted as the data indicating a place-name and a terrain, from data that the document processing apparatus 100 can adopts; and then inputs the data in the map component 72. Thereby, the map component 72 can render a map.

By receiving data indicating a condition for deciding a color and data indicating a figure to be rendered with the decided color, the color component 74 has a function of rendering the figure with the color corresponding to the condition. For example, even in the case where data indicating a place-name, a terrain, and a population of a place, are described in another document, when the cooperative control component 71 extracts the data indicating a population, a condition for deciding a color in accordance with a population, and a terrain, and inputs those data in the color component 74, the color component 74 can color a map with the color decided in accordance with the population for each place.

The progress bar component 76 has a function that, when time-series data is inputted in an activated processing system, the inputted data is switched along the time axis. When the progress bar component 76 issues an instruction that the inputted data is to be changed to the past data or the future data, the processing system in which the time-series data is inputted changes the inputted data as instructed, and executes the processing again to update the display.

The processing system may also have a function that the system outputs a result of processing the inputted data, or data described in a document to be processed, such that the result or the data can be used by another processing system as data to be inputted. In this case, each processing system defines a specification and a condition of data to be outputted, and notifies them to the cooperative control component 71. When the processing system completes processing by itself, the system may also create the data to be outputted as a DOM, or create the data to be outputted when the cooperative control component 71 requests the output of the data. Outputted data may be provided to a successive processing system as entity data, or only a pointer to the outputted data may be provided. In the latter case, a plurality of processing systems may refer to the same DOM, and each processing system may process the data of the DOM that is referred to, by mapping the data to the data to be inputted in its processing system, in the same way as with the VC function described in the Base Technology. In the case where each processing system receives data editing via a created view, the processing system issues an editing event instructing that the DOM to be referred to is to be modified, to a processing system that manages the DOM to be referred to, as described in the Base Technology. Upon reception of a mutation event indicating that the DOM has been modified, the processing system may update the view by reflecting the modification of the DOM to be referred to, in the DOM managed by the processing system itself.

A processing system may also be a system developed only for the function of cooperating data as described in the present embodiment, or be a system for processing each tag set as described in the Base Technology. In the latter case, in order for the processing system to be able to receive data of another document or data outputted from another processing system, as data to be inputted, the interface of the processing system may also be extended. Or, the cooperative control component may also provide the data of another document or data outputted from another processing system, to the processing system after mapping those data to a tag set that can be processed by the processing system, in the same way as with the VC function described in the Base Technology.

In the state where a document to be processed is not opened, the cooperative control component 71 displays a plain data sheet. When a user opens a document to be processed by dropping the document in the data sheet, etc., a processing system that processes the document is activated under the management of the cooperative control component 71.

The cooperative control component 71 manages a document opened in the data sheet and a processing system activated in the data sheet by assigning layers to them. When a document is opened in the data sheet, the cooperative control component 71 creates a new layer for the document and manages the exchange of data between layers. When a plurality of processing systems are activated and a plurality of layers are created, the display control component 77 may display screens of each layer that are outputted by those processing systems in a superimposed manner. Each layer may be provided with a check box for switching display/non-display. In this case, the display control component 77 makes a view created by a processing system that handles the display of a layer instructed as being non-displayed, non-displayed. A layer may also be provided with tabs in an order of being opened in the data sheet, such that an active layer to be processed can be switched by the tabs. Also, the order of the layers may be changed by drag and drop of the tags. At the time, the display control component 77 may also change the order of displaying screens, and the cooperative control component 71 may also change the order of processing data or combining data. Alternatively, the order of combining data and the order of displaying screens may be managed separately.

A plurality of documents or processing systems may be assigned to a single layer. For example, data described in a plurality of documents may also be grouped to be assigned to a single layer. A plurality of processing systems may also be grouped to be assigned to a single layer, such that data described in a document can be processed by the plurality of the processing systems. It is also possible that a layer to which a plurality of processing systems are assigned after being grouped, is maintained to be used widely, or a plurality of layers thus maintained are further combined together to be used.

A data sheet, which is a platform for cooperation of data, is described in a vocabulary (hereinafter, the prefix of the name space of the vocabulary is designated as “cascadexmlObject”) that is to be processed by the cooperative control component 71. In a source document designating the data sheet, elements in which a path and a title of a document, which is opened in the data sheet as a document to be processed, are stored, and an element in which an identifier of a document corresponding to each layer is stored, are described. Accordingly, a plurality of documents and a plurality of processing systems that have been combined in the data sheet, are recorded in the source document, thereby the data sheet in which data of the documents are cooperated can be reproduced, when the source document is opened.

The data described in a document that is opened in a data sheet may be added in the source document, or be managed separately as a DOM of each document. In the former case, although a data amount of the source document is large, it is convenient for exchanging data or the like, because all of the necessary data are included in the source document when the data sheet is opened.

The cooperative control component 71 may acquire a plurality of documents and extract, among data described in those documents, a combination of data that can be cooperated together, such that the combination is presented to a user. When the user analyzes various data described in a plurality of documents, a supporting technology is needed in which a correlative relationship and a cause-and-effect relationship between data can be presented in a visually understandable manner. In the case, even if a correlative relationship between data, which has been defined in advance, is visualized, a new discovery on the relationship of the data cannot be expected because of being limited within the range of correlative relationship thus set. However, when the number of documents or data to be referred to is large, the number of the combinations of the data is increased in an exponential manner; hence, it is no longer possible that a man/woman analyzes the whole combinations. Therefore, the cooperative control component 71 extract and presents combinations of data in which a high correlation or a cause-and-effect relation between data is likely to exist, after combining the data described in given documents in various ways. At the time, the cooperative control component 71 may also weigh the combinations of data with reference to degrees of similarity of elements names or attribute names, those of hierarchical structures, and those of data types.

The cooperative control component 71 may also input various combinations of a plurality of data included in given documents, as data to be inputted in an available processing system that is installed in the document processing apparatus 100. Thereafter, the cooperative control component 71 may present a display screen created by the processing system to the user. The cooperative control component 71 may also determine a processing system that is activated based on data. In the case where a plurality of processing systems are present, the processing systems may be combined in various ways. Or, a process system may be applied multiple times. The advancement of the sequential processing by combining a plurality of data and processing systems in various ways, can also serve as an simulator of events. Data and a processing system may be replaced later. In this way, user's decision-making can be supported by the cooperation of data and processing systems in various ways.

The present invention has been described above in conjunction with the embodiments thereof. The embodiment has been given solely by way of illustration, and it will be understood by a person skilled in the art that various modifications may be made to combinations of the foregoing components and processes, and all such modifications are also intended to fall within the scope of the present invention.

In the embodiment, an example in which an XML document is processed has been mentioned; however, the document processing apparatus 100 of the present embodiment can process a document described in other markup languages, for example, SGML, HTML etc., as well.

### INDUSTRIAL APPLICABILITY

The present invention can be used in a document processing apparatus that processes a document structured by a markup language.

1. A data processing apparatus comprising:
an acquiring unit that acquires data described in a markup language;
a processing system in which certain data is inputted and processed;
a cooperative control unit that extracts data to be inputted into the processing system from the data acquired by the acquiring unit; and
a display control unit that displays a screen outputted by the processing system in which the data, which is determined by the cooperative control unit, is inputted and processed.

2. The data processing apparatus according to claim 1, wherein, when a plurality of the processing systems are activated, the cooperative control unit extracts, from both of the data acquired by the acquiring unit and the data outputted by the processing system that has been previously activated, data to be inputted in the processing system that has been activated later.

3. The processing apparatus according to either claim 1, wherein, when a plurality of the processing systems are activated, the cooperative control unit can change an order in which the plurality of the processing systems process data.

4. The data processing apparatus according to claim 1, wherein, when a plurality of the processing systems are activated, the display control unit displays screens outputted by the plurality of the processing systems in a superimposed manner.

5. The data processing apparatus according to claim 4, wherein, when a plurality of the processing systems are activated, the display control unit can change an order in which screens outputted by the plurality of the processing systems are displayed.

6. The data processing apparatus according to claim 1, wherein the cooperative control unit extracts data to be inputted in the processing system based on at least one of an element name, an attribute name, a name space, and a data type.

7. The data processing apparatus according to claim 1, wherein the cooperative control unit determines data to be inputted in the processing system, by presenting a candidate for the data to be inputted in the processing system to a user, and by receiving a selection of the data to be inputted therein from the user.

8. The data processing apparatus according to claim 1, wherein the cooperative control unit determines a processing system to be activated, based on the data.

9. A computer implemented data processing method comprising:
acquiring data described in a markup language;
extracting data to be inputted in a processing system that processes certain data, from the data acquired; and
displaying a screen outputted by the processing system that has processed the data thus extracted and inputted.

10. A computer program product comprising:
a module that acquires data described in a markup language;
a module that extracts data to be inputted in a processing system that process certain data, from the data acquired; and
a module that displays a screen outputted by the processing system that has processed the data thus extracted and inputted.
